(19) United States
(12) Patent Application Publication
(10) Pub. No.: US 2002/0100521 A1
(43) Pub. Date: Aug. 1, 2002

(54) Soldering flux

(76) Inventors: Ashraf I Sameja, London (GB); Anthony E. Ingham, London (GB)

Correspondence Address: Carol H Peters, Mintz Levin Cohn Ferris Glovsky and Popeo PC, ONE Financial Center, Boston, MA, 02111, US

(21) Appl. No.: 09/501,794

(22) Filed: Feb. 8, 2000

(51) Int. Cl. B23K 35/34

(52) U.S. Cl. 148/23

(57) ABSTRACT

Soldering flux compositions are provided useful for soldering radiators of motor vehicles and heat exchanger assemblies in general. Soldering flux compositions include certain fluorine containing compounds found to reduce the undesirable formation of flux tank precipitates and staining of soldered products. Such soldering flux compositions do not compromise the performance of soldering flux in terms of flux efficiency and high temperature life.

### This invention is concerned with soldering fluxes, particularly with soldering fluxes which are useful for soldering the radiators of motor vehicles and heat exchanger assemblies in general.

Various soldering procedures are used in the manufacture of car radiators and heat exchanger assemblies. One of these is the baking procedure which involves clamping an assembly of solder coated tubes and other radiator components in a jig, spraying with flux or dipping the assembly in flux and baking the assembly in an oven. This procedure requires the assembly to remain in the oven at elevated temperature usually for several minutes. The oven temperature may be anything from 250 to 470° C. but is more likely to be in the range 280 to 400° C. During this procedure the solder will melt and flow into the crevices in the joints of the assembly thereby providing the necessary bonding. Another soldering process used in these industries is end-dipping and this also involves exposure to high temperature.

The flux used in these soldering processes must therefore have a sufficiently long high temperature life to ensure that it will provide sufficient protection to the surfaces to be joined until the radiator has attained a temperature sufficient to melt the solder and thereby permit bonding. Other desirable properties of fluxes are that they should produce low levels of char and residue and of course have a good fluxing efficiency.

Examples of fluxes which have previously been developed for such uses are described in British Patents Nos. 1517116 and 1553069 and in European Patent No.610031. GB-A-1517116 discloses a soldering flux which comprises an aqueous solution containing a mixture of 25 to 75% by weight of hydrobromide of an aliphatic hydroxyamine and 75 to 25% by weight of a hydrobromide of an aliphatic amine. GB-A-1553069 is a development of this which describes and claims a flux which comprises an aqueous solution containing a mixture of diethanolamine hydrobromide and ethylamine hydrobromide together with ammonium bromide. EP-A-610031 is a further development which discloses a non-chelating soldering flux which comprises an aqueous solution containing one or more hydrohalides or hydrophosphates of guanidine, substantial guanidine or a five-membered nitrogen containing heterocyclic amine and one or more hydrohalides or hydrophosphates of aliphatic amines.

Other fluxes used in soldering copper and brass surfaces in heat exchangers use zinc chloride and zinc bromide, often in combination with some ammonium chloride, ammonium bromide, hydrochloric or hydrobromic acid.

The solders which are currently used in this field are alloys of tin and lead. However, there is now a considerable demand for the use of solders which are free from lead. Consequently, there is some experimentation with the use of lead-free alloys in this area. Examples of such alloys include alloys of tin and copper.

However, there are problems with the use of lead-free solder in conjunction with the soldering fluxes known in the art. These problems are particularly noticeable when a baking procedure such as that described above for the production of radiators and heat exchanger assemblies is used. The first problem is that there is a tendency for precipitates to build up quickly in the flux tank into which the assembly is dipped prior to baking. Analysis of the precipitates indicates that they comprise tin and oxygen and/or bromine. The formation of such precipitates is undesirable and may also be related to the second problem. The second problem is that, when soldering is complete, a white staining develops on the surfaces of the soldered product either immediately or within 24 hours of the soldering operation. This deposit is believed to be a complex of tin and hydroxide and/or bromide ions. Again the deposit is undesirable and its formation represents a disadvantage of the use of presently known soldering fluxes.

The applicants have carried out extensive laboratory testing in order to discover compositions which reduce the rate of formation of precipitate and which reduce the staining of the soldered product and which do not compromise the performance of the flux in terms of its fluxing efficiency and high temperature life. Initial experiments using conventional corrosion inhibitors such as urea, thiourea, 2-phenyl-2-thiourea, 2-mercapto-benzothioazole, 2-mercapto-benzoimidazole, dibenzyl sulphoxide, thiosemicarbazide, 6-methoxypurin, 5-phenyltetrazole, benzotriazole and dimethyl acetylenedicarboxylate (DMAD) proved unsuccessful. Finally it was discovered that the precipitation of tin salts could be delayed by the addition of certain fluorine-containing compounds to a conventional flux. Addition of such compounds was also found to reduce the staining of the soldered products and to provide fluxes with fluxing efficiencies as good as and sometimes better than those known in the art.

Accordingly, the present invention provides a soldering flux composition which comprises:

(i) zinc bromide and/or one or more amine hydrohalides and/or one or more amine hydrophosphates in an amount of from 30 to 99.5 wt % based on the total weight of components (i) and (ii); and

(ii) one or more fluorine-containing compounds selected from fluoroboric acid, ammonium fluoroborate, lithium fluoroborate, sodium fluoroborate, potassium fluoroborate, lithium fluoride, sodium fluoride and potassium fluoride in an amount of from 70 to 0.5 wt % based on the total weight of components (i) and (ii); and

(iii) water in an amount not less than that required to solvate components (i) and (ii).

Preferably, component (i) is present in an amount of from 60 to 95 wt % based on the total weight of components (i) and (ii) and component (ii) is present in an amount of from 40 to 5 wt % based on the total weight of components (i) and (ii).

More preferably, component (i) is present in an amount of from 70 to 95 wt % based on the total weight of components (i) and (ii) and component (ii) is present in an amount of from 30 to 5 wt % based on the total weight of components (i) and (ii).

Even more preferably, component (i) is present in an amount of from 90 to 95 wt % based on the total weight of components (i) and (ii) and component (ii) is present in an amount of from 10 to 5 wt % based on the total weight of components (i) and (ii).

Suitable amine hydrohalides may be selected from hydrohalides of:

(a) aliphatic monoamines, such as ethylamine and propylamine; and/or

(b) aliphatic diamines, such as 1,2-diaminoethane, 1,5-diaminopentane, and 1,6-diaminohexane; and/or

(c) hydroxyamines, such as ethanolamine and diethanolamine; and/or

(d) monobasic amino acids, such as beta-alanine and valine;

(e) 5-membered nitrogen-containing heterocyclic amines, such as 5-aminotetrazole and 3-amino-1,2,4-triazole; and/or

(f) guanidine or a substituted guanidine; and/or

(g) amidoamines, such as urea.

Preferably, the amine hydrohalides are amine hydrobromides.

It will be appreciated by a person skilled in the art that, although the relative concentrations of the compounds which make up components (i) and (ii) may only vary within the ranges specified above, the total concentration of the compounds which make up components (i) and (ii) may vary considerably within the scope of the invention. In other words, the amount of water present will vary from one composition to another depending upon the strength of flux required for a particular job. The flux composition of the present invention will commonly be supplied as a concentrated solution and the user may use it as received, but will often dilute it with water prior to use. The final concentration will depend on the type of process for which the flux is to be used, the temperature—time profile of the heating ovens, and the type and age of the radiator materials, for example tubes or fins.

The scope of the present invention is thus not limited by the total concentration of components (i) and (ii) in the flux composition. However, the total concentration of component (ii) may typically vary in the range of from 0.1 to 5.0 wt % based on the total weight of the flux. By way of example, a concentrated, or “strong”, flux composition may comprise a total concentration of component (ii) in an amount of from 0.5 to 5 wt % based on the total weight of the flux. A dilute, or “weak”, flux composition may comprise a total concentration of component (ii) in an amount of from 0.1 to 0.5 wt % based on the total weight of the flux.

The compositions of the present invention may also contain an ammonium halide in an amount of up to 400% by weight, preferably up to 150% by weight, based on the total weight of component (i). Preferably the ammonium halide is ammonium bromide.

The compositions of the present invention may also comprise free hydrohalic acid and/or phosphoric acid. I.e. the compositions may comprise hydrohalic acid and/or phosphoric acid in an amount in excess of that required to ensure that all amine compounds are present as amine hydrobromides or amine hydrophosphates. The hydrohalic acid and/or phosphoric acid may preferably be present in an amount of up to 800% by weight based on the total weight of component (i). When a hydrohalic acid is present it is preferably hydrobromic acid, in which case it is preferably added as a 48% aqueous solution.

The compositions of the present invention may also contain one or more wetting agents and/or corrosion inhibitors. Examples of suitable corrosion inhibitors are benzotriazole and imidazole. Typically, the wetting agent(s) and/or corrosion inhibitor(s) may each be present in an amount of up to 10% by weight, more preferably up to 5% by weight, even more preferably approximately 3% by weight, based on the total weight of components (i) and (ii).

### The present invention will be further described by the following examples which are intended to illustrate but not to limit, the scope of the present invention.

### EXAMPLE 1

A soldering flux according to the present invention was produced containing the following components:

| Material | Amount (g) |
|---|---|
| HBr | 7.9 |
| Guanidine Hydrobromide | 8.7 |
| Monoethylamine Hydrobromide | 11.6 |
| Ammonium Bromide | 3.5 |
| Ammonium Fluoroborate | 1.9 |
| Wetting Agents | 0.8 |
| Water | 65.5 |

The compounds making up component (i) are present in an amount of 91.4 wt % (i.e. guanidine hydrobromide (39.4 wt %) and monoethylamine hydrobromide (52.0 wt %)), based upon the total weight of components (i) and (ii). The compound making up component (ii) is present in an amount of 8.6 wt % (i.e. ammonium tetrafluoroborate (8.6 wt %)) based upon the total weight of components (i) and (ii).

The compound making up component (ii) is present in an amount of 1.9 wt % based upon the total weight of the flux, thus this flux falls into the “strong” category.

### EXAMPLE 2

A soldering flux according to the present invention was produced by mixing the following components:

| Material | Amount (g) |
|---|---|
| Zinc bromide | 310 |
| Ammonium bromide | 210 |
| 48% hydrobromic acid | 21 |
| Ammonium flouroborate | 18 |
| Wetting agents | 5 |
| Water | 436 |

### EXAMPLE 3

A first flux composition was prepared as in example 1 above. A second flux composition was prepared as in example 1 above but omitting the ammonium tetrafluoroborate. Both fluxes were diluted one part flux to ten parts water. 500 ml of each flux was placed in separate beakers. Into each beaker was immersed a copper strip or strips to a total weight of 17 g and tin wire of weight 50 g. The tin and copper were touching to allow any possible galvanic action to occur. The solutions were observed and it was recorded that, after 3 days immersion, the second flux composition containing no ammonium tetrafluoroborate had developed a white haze. After the same period of time the first flux composition remained clear. After 5 days immersion the haze in the second flux composition had developed to form a cloudy mixture with a distinct yellowish-white precipitate. After 5 days the first flux composition remained clear and continued to remain clear for a further 10 days before the development of a precipitate was observed.

### EXAMPLE 4

A first flux composition was prepared as in example 1 above. A second flux composition was prepared as in example 1 above but omitting the ammonium tetrafluoroborate. Both fluxes were diluted one part flux to ten parts water. A number of copper and tin samples were prepared with the two metals clipped to each other. One sample was immersed in each of the two flux compositions for a period of 20 mins. After 20 mins immersion the two copper/tin samples were removed and each was replaced with a fresh sample. After 20 mins immersion these samples were also removed and replaced. This example mimics to some extent an industrial dipping process. After 160 mins (8 samples) the second flux composition had become cloudy and a whitish precipitate had begun to develop. After the same amount of time and samples the first flux solution remained clear. The test was continued with the first flux only and it still remained clear after 1000 mins (50 samples).

### EXAMPLE 5

The method of example 3 was repeated using as a first flux a composition prepared as in example 2 above. A second flux composition was prepared as in example 2 above but omitting the ammonium tetrafluoroborate. After 16 hrs the second flux composition had turned cloudy. The first flux composition remained clear for 90 hrs.

### EXAMPLE 6

A flux composition was prepared as in Example 1 above. Further flux compositions were prepared as in Example 1 above with the ammonium fluoroborate being replaced with various different chemicals in an amount of 2% w/w. A control composition was also prepared as in Example 1 above but excluding the ammonium fluoroborate. The resultant compositions were then diluted with 1 part water to 1 part flux. Metal test-pieces were made by winding “lead-free” solder (97 Sn/3 Pb) in the form of a wire (20 cm long and 2.5 mm diameter) around copper foil (0.5 mm thickness, 5 cm wide and 10 cm long). A test-piece was then immersed in each of the fluxes and the appearance of the fluxes was monitored daily to identify when a precipitate appeared. The table below indicates with a cross the day upon which contamination of each flux with precipitate was observed (the flux containing ammonium fluoroborate remained clear after 10 days).

| Chemical | | | | | | | | | | |
|---|---|---|---|---|---|---|---|---|---|---|
| tested at 2% | Number of Days | | | | | | | | | |
| w/w of flux | 1 | 2 | 3 | 4 | 5 | 6 | 7 | 8 | 9 | 10 |
| No additive | | | | X | | | | | | |
| (control) | | | | | | | | | | |
| Ammonium | | | | | | | | | | |
| fluoroborate | | | | | | | | | | |
| Sodium | | | | | | | | X | | |
| fluoroborate | | | | | | | | | | |
| Potassium | | | | | | | | | | X |
| fluoroborate | | | | | | | | | | |
| Fluoroboric | | | | | | | | X | | |
| acid (48% sol) | | | | | | | | | | |
| Sodium | | | | | | | | | | X |
| fluoride | | | | | | | | | | |
| Potassium | | | | | | | | X | | |
| fluoride | | | | | | | | | | |

### EXAMPLE 7

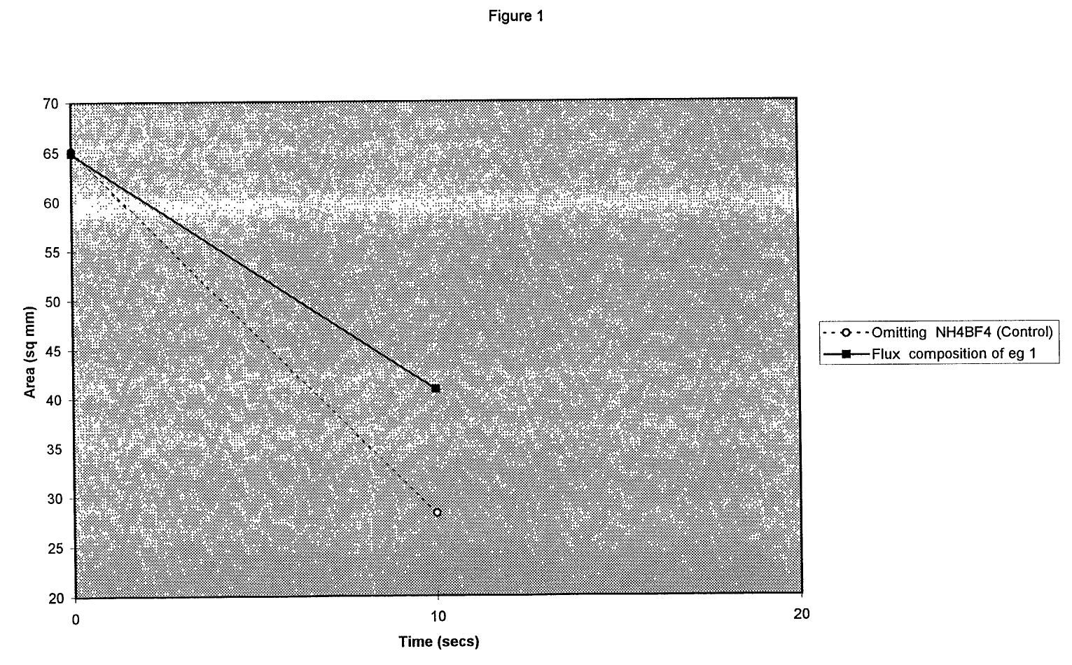

A first flux composition was prepared as in example 1 above. A second flux composition was prepared as in example 1 above but omitting the ammonium tetrafluoroborate. Both fluxes were diluted one part flux to ten parts water. In order to demonstrate the fluxing efficiency of the fluxes “spread tests” were carried out as follows. A copper test-plate is placed on the surface of a molten bath of solder (temperature =350° C.). A drop of flux is placed on the copper test-plate and, after a period of time, a small pellet of solder of a certain mass is placed on the spot where the flux was dropped. The solder pellet melts and spreads out on the test-plate. The test-plate is then removed from the molten bath and allowed to cool so that the solder solidifies. The area of the test-plate which has been covered by solder is then measured. A larger area indicates a more efficient flux. FIG. 1 shows a plot of the spread area for both fluxes for different time periods before deposition of the pellet. The plot indicates that the flux of the present invention has a fluxing efficiency at least as good as that of the known control composition. It also indicates that the high-temperature life of the flux of the present invention is better than that of the known control composition with a smaller decrease in fluxing efficiency occurring as the time period before deposition of the pellet is increased.

### EXAMPLE 8

Flux solutions of the present invention were used in an oven baking process to solder the components of a number of radiators. A flux of the composition given in example 1 was prepared. It was diluted with water in the ratio of 1 part flux: 10 parts water. Each radiator core was immersed in flux, withdrawn and excess flux drained from it. The fluxed radiator cores were then passed through a tunnel oven and baked at 320° C. The passage through the oven took between 4 and 7 minutes depending on the size of the core. A flux composition of example 1 was prepared. It was diluted with water in the ratio of 1 part flux: 2 parts water. The resulting flux solution was used in the process to solder the tank plates to the tubes. The parts of the radiator to be soldered by this process were coated with flux by dipping, and then immersed in solder at 365° C. for 30-45 seconds. At the end of a weeks production the flux tanks remained clear, and the radiators produced were clean and showed no occurrence of staining.

Thus, it can be seen that the compositions of the present invention provide fluxes which increase the time taken for undesirable precipitates to appear therein and which do not result in undesirable staining of the soldered product and which maintain fluxing efficiencies and high temperature lifetimes at least as good as compositions known in the art.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A soldering flux composition comprising:
(i) at least one compound selected from the group consisting of zinc bromide, amine hydrohalides, amine hydrophosphates and combinations thereof in an amount of from 30 to 99.5 wt % based on the total weight of components (i) and (ii); and
(ii) at least one compound selected from the group consisting of fluoroboric acid, ammonium fluoroborate, lithium fluoroborate, sodium fluoroborate, potassium fluoroborate, and combinations thereof in an amount from 70 to 0.5 wt % based on the total weight of components (i) and (ii); and
(iii) water in an amount not less than that required to solvate components (i) and (ii).

2. A soldering flux composition of claim 1, wherein component (i) is present in an amount of from 60 to 95 wt % based on the total weight of components (i) and (ii), and component (ii) is present in an amount of from 40 to 5 wt % based on the total weight of components (i) and (ii).

3. A soldering flux composition of claim 1, wherein component (i) is present in an amount of from 70 to 95 wt % based on the total weight of components (i) and (ii), and component (i) is present in an amount of from 30 to 5 wt % based on the total weight of components (i) and (ii).

4. A soldering flux composition of claim 1, wherein component (i) is present in an amount of from 90 to 95 wt % based on the total weight of components (i) and (ii), and component (ii) is present in an amount of from 10 to 5 wt % based on the total weight of components (i) and (ii).

5. A soldering flux composition of claim 1, wherein the amine hydrohalide is selected from the group consisting of aliphatic monoamines, aliphatic diamines, hydroxyamines, monobasic amino acids, 5-membered nitrogen-containing heterocyclic amines, guinidine, substituted guanidines, amidoamines and combinations thereof.

6. A soldering flux composition of claim 1, wherein the amine hydrohalide is selected from the group of hydrohalides consisting of ethylamine, propylamine, 1,2-diaminoethane, 1,5-diaminopentane, 1,6-diaminohexane, ethanolamine, diethanolamine, beta-alanine, valine, 5-aminotetrazole, 3-amino-1,2,4-triazole, guanidine, urea and combinations thereof.

7. A soldering flux composition of claim 1, wherein the amine hydrohalide is an amine hydrobromide.

8. A soldering flux composition of claim 1, wherein the concentration of component (ii) is in the range of from 0.1 to 5.0 wt % based on the total weight of the flux.

9. A soldering flux composition of claim 1, wherein the concentration of component (ii) is in the range of from 0.5 to 0.5 wt % based on the total weight of the flux.

10. A soldering flux composition of claim 1, further comprising an ammonium halide present in an amount of up to 400% by weight based on the total weight of component (i).

11. A soldering flux composition of claim 10, wherein the ammonium halide is ammonium bromide.

12. A soldering flux composition of claim 1, further comprising a compound selected from the group consisting of hydrohalic acid, phosphoric acid and combinations thereof in an amount up to 800% by weight based on the total weight of component (i).

13. A soldering flux composition of claim 12, wherein the hydrohalic acid is hydrobromic acid.

14. A soldering flux composition of claim 1, further comprising at least one additive selected from the group consisting of wetting agents, corrosion inhibitors and combinations thereof.

15. A soldering flux composition of claim 14, wherein the corrosion inhibitor is selected from the group consisting of benzotriazoles, imidazoles and combinations thereof.

16. A soldering flux composition of claim 15, wherein the additives are each present in an amount of up to 10% by weight based o the total weight of components (i) and (ii).

17. A method for delaying the formation of undesirable precipitates in a soldering flux composition comprising steps of:
adding to the soldering flux composition at least one compound selected from the group consisting of fluoroboric acid, ammonium fluoroborate, lithium fluoroborate, sodium fluoroborate, potassium fluoroborate, lithium fluoride, sodium fluoride, potassium fluoride and combinations thereof.
